(19) United States
(12) Patent Application Publication
(10) Pub. No.: US 2023/0229137 A1
(43) Pub. Date: Jul. 20, 2023

(54) ANALYSIS DEVICE, ANALYSIS METHOD AND NON-TRANSITORY COMPUTER-READABLE STORAGE MEDIUM

(71) Applicant: OMRON CORPORATION, Kyoto-shi (JP)

(72) Inventors: Shinya FUJIMOTO, Kyoto-shi (JP); Naoya HASHIMOTO, Kyoto-shi (JP); Takao KOMOTO, Kyoto-shi (JP); Makoto KAWAI, Kyoto-shi (JP); Daiki SUGIYAMA, Kyoto-shi (JP); Hideki YACHIKU, Kyoto-shi (JP); Hirokazu FURUSAWA, Kyoto-shi (JP)

(73) Assignee: OMRON CORPORATION, Kyoto-shi (JP)

(21) Appl. No.: 18/145,445

(22) Filed: Dec. 22, 2022

(30) Foreign Application Priority Data
Jan. 20, 2022 (JP) 2022-007038

(51) Int. Cl. G05B 19/406

(52) U.S. Cl. CPC G05B 19/406; G05B 2219/50185

(57) ABSTRACT

An analysis device includes: a first acquisition unit that acquires data indicating a first time zone in which each product stays in each of a plurality of processes; a second acquisition unit that acquires data indicating a second time zone in which a worker stays in each of the plurality of processes; an analyzer that analyzes a work situation for each product in each of the plurality of processes; and a providing unit that provides an analysis result. The analyzer determines, on the basis of a relationship between the first time zone and the second time zone in a period for analysis of a process for analysis, whether or not a factor that decreases work efficiency has occurred in the period for analysis of the process for analysis.

### BACKGROUND OF THE INVENTION

### Field of the Invention

The present disclosure relates to an analysis device, an analysis method, and a non-transitory computer-readable storage medium.

### Description of the Background Art

In a production site including a plurality of processes, work analysis is performed to improve work efficiency. For example, Japanese Patent Laying-Open No. 2012-22602 discloses a technique of drawing a running chart that has a vertical axis representing process and a horizontal axis representing time and that visualizes positions of a workpiece and a worker with respect to process and time. According to the technique disclosed in Japanese Patent Laying-Open No. 2012-22602, the work situation of a line can be grasped by checking the running chart.

### SUMMARY OF THE INVENTION

In the technique disclosed in Japanese Patent Laying-Open No. 2012-22602, it is not possible to determine whether or not there is a decrease in work efficiency unless a user is familiar with the running chart.

The present disclosure has been made in view of the above problems, and an object of the present disclosure is to provide an analysis device, an analysis method, and a non-transitory computer-readable storage medium with which it is possible to easily recognize whether or not there is a decrease in work efficiency.

According to an example of the present disclosure, an analysis device of a manufacturing system including a plurality of processes includes a first acquisition unit, a second acquisition unit, an analyzer, and a providing unit. The first acquisition unit acquires data indicating a first time zone in which each product stays in each of the plurality of processes. The second acquisition unit acquires data indicating a second time zone in which a worker stays in each of the plurality of processes. The analyzer analyzes a work situation for each product in each of the plurality of processes. The providing unit provides an analysis result from the analyzer. The analyzer determines, on the basis of a first relationship between the first time zone and the second time zone in a period for analysis of a process for analysis, whether or not a factor that decreases work efficiency has occurred in the period for analysis of the process for analysis.

According to the present disclosure, an analysis for determining whether or not the factor of decreasing the work efficiency has occurred on the basis of the relationship between the first time zone and the second time zone is performed, and an analysis result is provided. As a result, the user can easily recognize whether or not there is a decrease in work efficiency.

In the above disclosure, the analyzer stores, for each classification of the process, information in which a condition for defining the relationship between the first time zone and the second time zone is associated with a type of the factor that decreases work efficiency. The analyzer specifies, for each of the plurality of processes, a type of the factor associated with the condition satisfied by the first relationship from the information corresponding to the classification to which the process belongs. According to this disclosure, the user can recognize the type of the factor of decreasing the work efficiency.

In the above disclosure, the providing unit provides a graph with a first axis representing a process forward direction and a second axis representing time, displays the first time zone and the second time zone on the graph, and displays the period for analysis that has been determined to have the factor in a display format different from a display formant of a remaining period.

According to this disclosure, the user can easily recognize the period for analysis in which the factor of decreasing the work efficiency has occurred by checking the graph.

In the above disclosure, the analyzer specifies a third time zone in which the factor occurs in the period for analysis that has been determined to have the factor. The providing unit provides a graph with a first axis representing a process forward direction and a second axis representing time, displays the first time zone and the second time zone on the graph, and displays the third time zone in a different display format depending on the type of the factor specified by the analyzer.

According to this disclosure, the user can easily recognize the third time zone in which the factor of decreasing the work efficiency has occurred by checking the graph.

In the above disclosure, the providing unit provides a graph with a first axis representing a process forward direction and a second axis representing time, displays the first time zone and the second time zone on the graph, and displays, in the graph, a text indicating the type of the factor specified by the analyzer in the period for analysis that has been determined to have the factor.

According to this disclosure, the user can easily recognize the type of the factor of decreasing the work efficiency by checking the graph.

In the above disclosure, the providing unit stores, for each of the plurality of processes, a fourth time zone in which the product stays and a fifth time zone in which the worker stays when standard work is performed. The providing unit displays a portion, in the first time zone and the second time zone displayed in the graph, different from the fourth time zone and the fifth time zone in a display format different from a display format of a remaining portion.

According to this disclosure, the user can easily recognize a time zone in which work different from the standard work is performed.

In the above disclosure, the providing unit provides a histogram indicating a distribution of time required for work on each product in a process of interest among the plurality of processes. Each section of the histogram represents a proportion of the factor identified by the analyzer for each type.

According to this disclosure, the user can easily recognize the factor of an increase in time required for the work by checking the histogram of the process of interest.

In the above disclosure, the analyzer specifies a third time zone in which the factor occurs in the first time zone and the second time zone that have been determined to have the factor. The providing unit further provides a simulation result of transition of a production volume of the product in a case of eliminating the third time zone.

According to this disclosure, the user can easily recognize how much the production volume increases by eliminating the factor of decreasing the work efficiency by viewing the simulation result.

According to an example of the present disclosure, an analysis method for a manufacturing system including a plurality of processes includes first to fourth steps. The first step is a step for acquiring data indicating a first time zone in which each product stays in each of the plurality of processes. The second step is a step for acquiring data indicating a second time zone in which a worker stays in each of the plurality of processes. The third step is a step for analyzing a work situation for each product in each of the plurality of processes. The fourth step is a step for providing an analysis result. The third step includes a step for determining, on the basis of a relationship between the first time zone and the second time zone in a period for analysis of a process for analysis, whether or not a factor that decreases work efficiency has occurred in the period for analysis of the process for analysis.

According to an example of the present disclosure, a program causes a computer to execute the above analysis method. With these disclosures, the user can easily recognize whether or not there is a decrease in work efficiency.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating an example of a manufacturing system to which an analysis device according to an embodiment is applied.

FIG. 2 is a block diagram illustrating a hardware configuration example of a programmable logic controller (PLC) of the manufacturing system according to the embodiment.

FIG. 3 is a diagram illustrating an example of a first time zone data group.

FIG. 4 is a schematic diagram illustrating a hardware configuration example of an information processing device.

FIG. 5 is a diagram illustrating an example of a second time zone data group.

FIG. 6 is a diagram illustrating an example of a frame included in a moving image acquired from a camera.

FIG. 7 is a schematic diagram illustrating a hardware configuration example of the analysis device according to the embodiment.

FIG. 8 is a diagram illustrating a functional configuration example of the analysis device according to the embodiment.

FIG. 9 is a flowchart illustrating a flow of analysis processing by the analysis device according to the embodiment.

FIG. 10 is a diagram illustrating an example of association information of “automatic” of a classification.

FIG. 11 is a diagram illustrating an example of the association information of “semi-automatic” of the classification.

FIG. 12 is a diagram illustrating an example of the association information of “manual” of the classification.

FIG. 13 is a diagram illustrating an example of classification information in which a process and a classification are associated with each other.

FIG. 14 is a flowchart illustrating a flow of a subroutine of step S3 illustrated in FIG. 9.

FIG. 15 is a diagram illustrating an example of a screen provided by the analysis device.

FIG. 16 is a diagram illustrating another example of the screen provided by the analysis device.

FIG. 17 is a diagram illustrating an example of a screen provided by an analysis device according to a first modification.

FIG. 18 is a diagram illustrating association information according to a fourth modification.

FIG. 19 is a diagram illustrating processing performed by a providing unit of an analysis device according to a fifth modification.

### DESCRIPTION OF THE PREFERRED EMBODIMENTS

An embodiment of the present invention will be described in detail with reference to the drawings. The same or corresponding parts in the drawings are denoted by the same reference signs, and the description thereof will not be repeated. Note that modifications described below may be appropriately and selectively combined.

### § 1 APPLICATION EXAMPLE

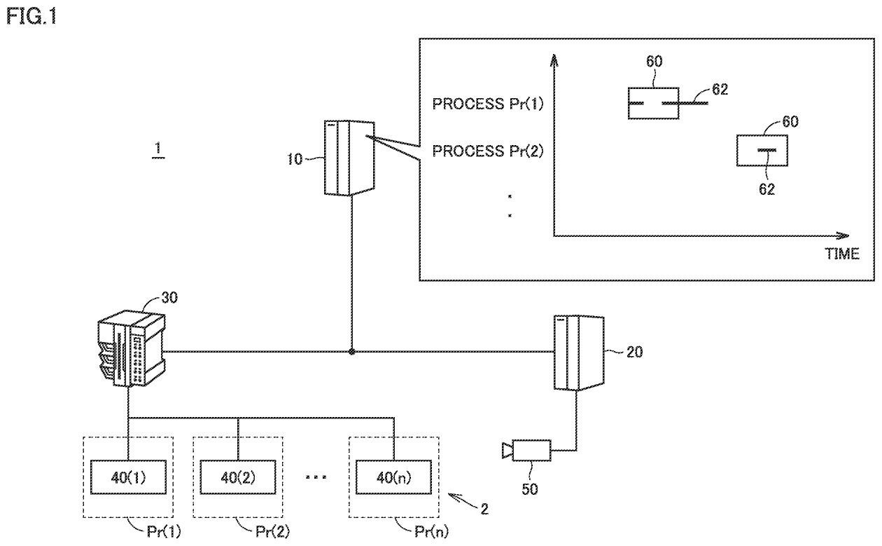

With reference to FIG. 1, an application example of an analysis device according to the present embodiment will be described. FIG. 1 is a diagram illustrating an example of a manufacturing system to which the analysis device according to the embodiment is applied. As illustrated in FIG. 1, a manufacturing system 1 includes an analysis device 10, an information processing device 20, a programmable logic controller (PLC) 30, multiple devices 40, and a camera 50.

Multiple devices 40 are installed in a production site 2. Production site 2 includes a plurality of processes Pr. In production site 2, various products are produced through a plurality of processes Pr, for example. Plurality of processes Pr include, for example, a “coating” process, a process of “assembling a main workpiece”, a process of “incorporating a main workpiece into a main body”, an “inspection” process, and the like. When it is necessary to distinguish the plurality of processes Pr from each other, indexes such as “(1)”, “(2)”, “(3)”, . . . , “(n)” are added to the reference numerals to distinguish them from each other. For example, they are distinguished by being described as “process Pr(1)”, “process Pr(2)”, . . . , and “process Pr(n)”. When it is not necessary to particularly distinguish the plurality of processes from each other, each of the plurality of processes is simply referred to as a “process Pr”.

Multiple devices 40 are used in the plurality of processes Pr, respectively. That is, process Pr and device 40 are associated with each other in advance. In a case where it is necessary to distinguish multiple devices 40 from each other, indexes such as “(1)”, “(2)”, . . . , “(n)” are added to the reference numerals to distinguish the devices from each other, and in a case where it is not particularly necessary to distinguish the devices, each of the devices is simply referred to as “device 40”. For example, one or more devices 40(m) are used to perform process Pr(m). That is, one or more devices 40(1) are used to perform process Pr(1). Similarly, one or more devices 40(2) are used to perform process Pr(2).

PLC 30 is a controller that entirely controls production site 2, and is communicably connected to each of multiple devices 40.

Various types of industrial Ethernet (registered trademark) are used as a network that communicably connects PLC 30 and multiple devices 40. As the industrial Ethernet (registered trademark), EtherCAT (registered trademark), Profinet IRT, MECHATROLINK (registered trademark) -III, Powerlink, SERCOS (registered trademark) -III, CIP Motion, and the like are known for example, and any of these protocols may be adopted. Further, a field network other than Industrial Ethernet (registered trademark) may be used. For example, in a case where motion control is not performed, DeviceNet, CompoNet/IP (registered trademark), or the like may be used.

PLC 30 operates as a master in a master-slave control system, and acquires information from each of multiple devices 40 as an input device (measurement device) as input data. PLC 30 executes arithmetic processing using the acquired input data in accordance with a user program incorporated in advance. PLC 30 determines a control content for the master-slave control system in response to the execution of the arithmetic processing, and outputs control data corresponding to the control content to each of multiple devices 40. PLC 30 repeatedly acquires input data from each of multiple devices 40 and outputs control data to each of multiple devices 40 at a predetermined cycle (control cycle).

The input data acquired from multiple devices 40 by PLC 30 includes data indicating that the product has arrived at each process Pr and data indicating that the conveyance of the product from process Pr to the next process has started. PLC 30 generates a set of data (hereinafter referred to as a “first time zone data group”) indicating a first time zone 60 in which each product stays in each process Pr on the basis of these data, and outputs the generated first time zone data group to analysis device 10.

Multiple devices 40 operate as slaves in the master-slave control system. Multiple devices 40 are input devices that repeatedly transmit input data to PLC 30 at predetermined control cycle, or output devices that repeatedly receive control data from PLC 30 at predetermined control cycle and operate according to the received control data. Multiple devices 40 may include, for example, a sensor (for example, a photoelectric sensor) as an input device that transmits a detection result and the like to PLC 30, a barcode reader that transmits a reading result, an inspection machine (tester) that transmits an inspection result, and the like. In addition, multiple devices 40 may include a programmable terminal (PT) to which multiple input devices are connected. Furthermore, multiple devices 40 may include a robot or the like as an output device that performs screw tightening, picking, and the like.

Camera 50 is installed at a position (typically, a ceiling) from which entire production site 2 can be viewed, and generates moving image data (hereinafter simply referred to as a “moving image”) by capturing an image of entire production site 2. Camera 50 is, for example, a wide-angle camera or an ultrawide-angle camera. Information processing device 20 is communicably connected to camera 50.

Information processing device 20 generates a set of data (hereinafter referred to as a “second time zone data group”) indicating a second time zone 62 in which a worker stays in each process Pr using the moving image acquired from camera 50, and outputs the generated second time zone data group to analysis device 10.

Analysis device 10 is, for example, a general-purpose computer, and is connected to a display device and an input device.

Analysis device 10 is communicably connected to PLC 30 and periodically acquires the first time zone data group. Further, analysis device 10 is communicably connected to information processing device 20, and periodically acquires the second time zone data group.

Analysis device 10 analyzes a work situation for each product in each of the plurality of processes Pr and provides an analysis result. Analysis device 10 performs analysis using first time zone 60 indicated by the first time zone data group and second time zone 62 indicated by the second time zone data group. Analysis device 10 sequentially selects a process for analysis from a plurality of processes Pr, and determines whether or not a factor that decreases the work efficiency occurs in a period for analysis of the process for analysis on the basis of the relationship between first time zone 60 and second time zone 62 in the period for analysis of the process for analysis.

For example, in process Pr in which the product is processed by the work performed by the worker, the time zone in which the product stays and the time zone in which the worker stays need to overlap with each other. For such process Pr, analysis device 10 may determine a time zone in which first time zone 60 and second time zone 62 do not overlap as a time zone in which the work efficiency is decreased.

In process Pr that does not need work by the worker, only the product stays in a time zone in which device 40 normally operates. For such process Pr, analysis device 10 may determine second time zone 62 as a time zone in which the worker is responding to a failure and the work efficiency is decreased.

As described above, analysis device 10 according to the present embodiment performs analysis for determining whether or not a factor of decreasing the work efficiency has occurred on the basis of the relationship between first time zone 60 and second time zone 62, and provides the analysis result. As a result, the user can easily recognize whether or not there is a decrease in work efficiency.

### § 2 SPECIFIC EXAMPLE

<Hardware Configuration of PLC>

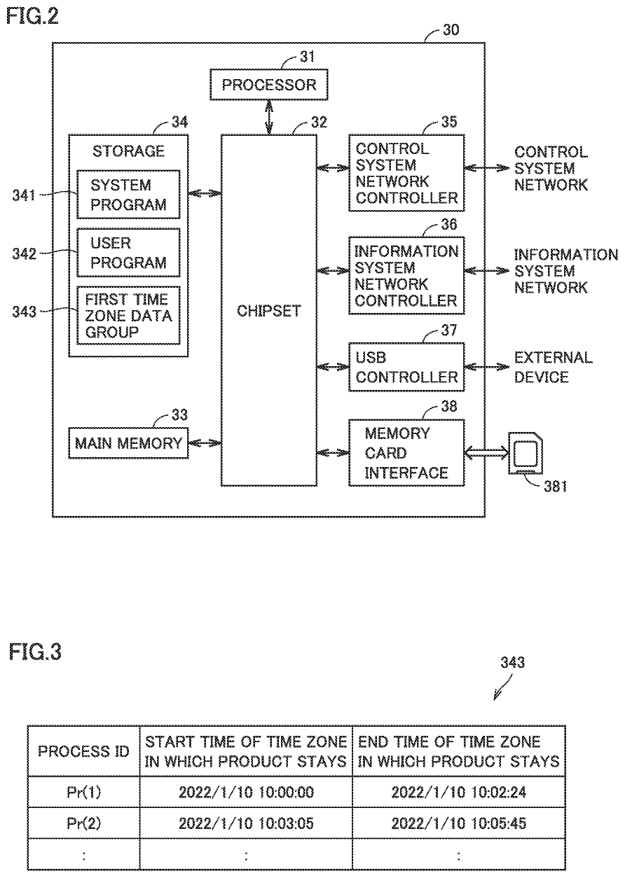

FIG. 2 is a block diagram illustrating a hardware configuration example of PLC 30 of manufacturing system 1 according to the present embodiment. As illustrated in FIG. 2, PLC 30 includes a processor 31 such as a central processing unit (CPU) or a micro-processing unit (MPU), a chipset 32, a main memory 33, a storage 34, a control system network controller 35, an information system network controller 36, a USB controller 37, and a memory card interface 38.

Processor 31 reads various programs stored in storage 34, expands the programs in main memory 33, and executes the programs, thereby implementing control calculation for controlling a control target. Chipset 32 controls data transmission and the like between processor 31 and each component.

Storage 34 stores a system program 341 for achieving basic processing, a user program 342 for achieving control calculation, and a first time zone data group 343.

Control system network controller 35 controls data exchange with multiple devices 40 at production site 2 via a control system network.

Information system network controller 36 controls data exchange with analysis device 10 and the like via an information system network.

USB controller 37 controls exchange of data with an external device (for example, a support device) via USB connection.

Memory card interface 38 is configured such that memory card 381 is attachable thereto and detachable therefrom, so that memory card interface 38 can write data to memory card 381 and read various kinds of data (user program, trace data, etc.) from memory card 381.

Processor 31 periodically collects various kinds of data from multiple devices 40 by executing user program 342. The data collected from multiple devices 40 includes data indicating presence/absence of a product in each process Pr. For example, data indicating presence/absence of a product is output from a sensor that detects objects. The sensor that detects objects includes, for example, a limit switch, a photoelectric sensor, and the like.

The data collected from multiple devices 40 may also include data indicating that a product has been set. The data indicating that the product has been set is generated by, for example, the worker pressing a button after inputting the product.

The data collected from multiple devices 40 may also include data indicating that a product has been removed. The data indicating that the product has been removed is generated by, for example, the worker pressing a product removal button.

Processor 31 generates first time zone data group 343 indicating the first time zone in which each product stays in each of the plurality of processes Pr on the basis of the data collected from multiple devices 40, and stores generated first time zone data group 343 in storage 34.

FIG. 3 is a diagram illustrating an example of the first time zone data group. First time zone data group 343 illustrated in FIG. 3 has a tabular form. Each record of first time zone data group 343 indicates one first time zone 60. That is, each record indicates a process ID for identifying process Pr, a start time of a time zone in which one product stays in process Pr, and an end time of the time zone. A time zone from the start time to the end time is first time zone 60. In production site 2, products are produced one by one. Therefore, when multiple products are sequentially produced, the operations in the plurality of processes Pr(1) to Pr(n) are repeatedly performed. Therefore, first time zone data group 343 includes multiple records indicating the same process ID.

First time zone data group 343 is periodically transmitted to analysis device 10 by information system network controller 36.

Although FIG. 2 illustrates the configuration example in which necessary processing is provided by processor 31 executing the program, some or all of these provided processing may be implemented using a dedicated hardware circuit (for example, ASIC or FPGA). Alternatively, the main part of PLC 30 may be implemented using hardware (for example, an industrial personal computer based on a general-purpose personal computer) in accordance with a general-purpose architecture. In this case, a plurality of OSs having different uses may be executed in parallel using a virtualization technology, and necessary applications may be executed on each OS.

<Hardware Configuration of Information Processing Device>

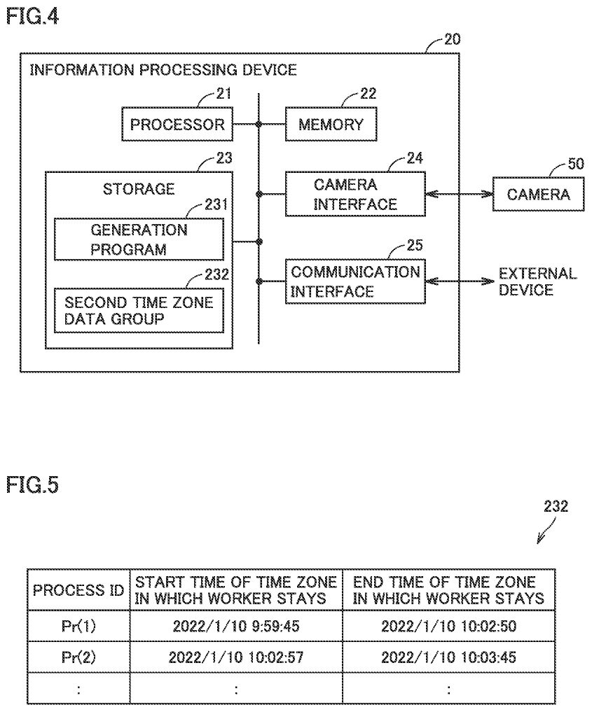

FIG. 4 is a schematic diagram illustrating a hardware configuration example of the information processing device. Typically, information processing device 20 has a structure according to a general-purpose computer architecture. As illustrated in FIG. 4, information processing device 20 includes a processor 21 such as a CPU or an MPU, a memory 22, a storage 23, a camera interface 24, and a communication interface 25. These components are connected to each other via a bus so as to be able to perform data communication.

Processor 21 implements various kinds of processing according to the present embodiment by expanding various programs stored in storage 23 in memory 22 and executing the programs.

Memory 22 is typically a volatile storage device such as a dynamic random access memory (DRAM), and stores a program read from storage 23, a moving image received from camera 50, and the like.

Camera interface 24 mediates data transmission between processor 21 and camera 50. More specifically, an imaging instruction is output from processor 21 to camera 50 via camera interface 24. Camera interface 24 outputs the moving image received from camera 50 to processor 21 in response to the imaging instruction.

Communication interface 25 mediates data transmission between processor 21 and an external device (for example, analysis device 10). Typically, communication interface 25 includes Ethernet (registered trademark), a universal serial bus (USB), and the like.

Storage 23 is typically a non-volatile magnetic storage device such as a hard disk drive. Storage 23 stores a generation program 231 executed by processor 21 and a second time zone data group 232 generated by execution of generation program 231.

FIG. 5 is a diagram illustrating an example of the second time zone data group. Second time zone data group 232 illustrated in FIG. 5 has a tabular form. Each record of second time zone data group 232 indicates one second time zone 62. That is, each record indicates a process ID for identifying process Pr, a start time of a time zone in which a worker stays in process Pr, and an end time of the time zone. A time zone from the start time to the end time is second time zone 62. In production site 2, products are produced one by one. Therefore, when multiple products are sequentially produced, the operations in the plurality of processes Pr(1) to Pr(n) are repeatedly performed. Therefore, second time zone data group 232 includes multiple records indicating the same process ID.

Second time zone data group 232 is periodically transmitted to analysis device 10 by communication interface 25.

A method for generating second time zone data group 232 on the basis of the moving image acquired from camera 50 will be described.

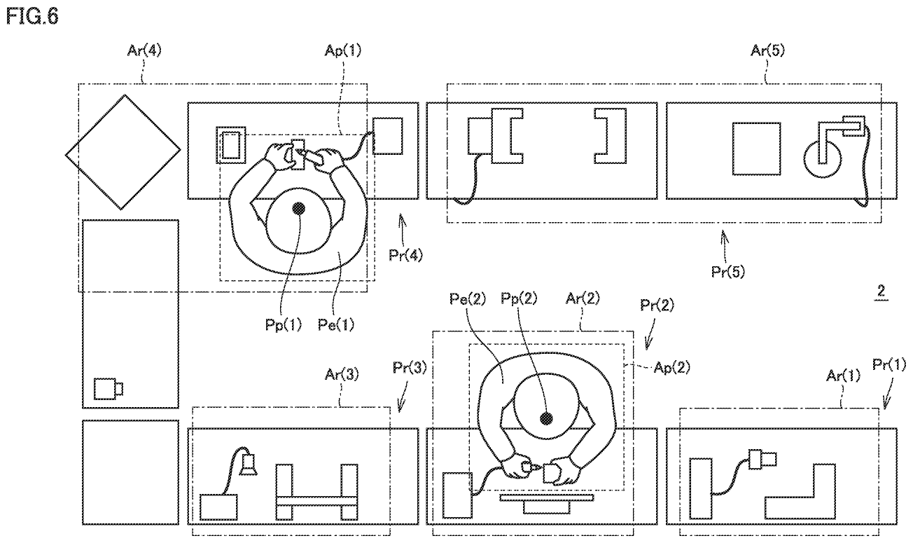

FIG. 6 is a diagram illustrating an example of a frame included in the moving image acquired from the camera. FIG. 6 illustrates a frame of a moving image obtained by imaging production site 2 including five processes Pr. As illustrated in FIG. 6, each frame of the moving image includes equipment (including device 40) installed at production site 2 and a worker Pe working in production site 2.

A monitoring area Ar is set in advance for each of five processes Pr. Specifically, monitoring areas Ar(1) to Ar(5) are set for processes Pr(1) to Pr(5), respectively. Monitoring areas Ar(1) to Ar(5) are regions in a frame of the moving image. Monitoring areas Ar(1) to Ar(5) are rectangular, for example, and are defined by coordinates of four vertexes.

Processor 21 detects the position of worker Pe in the frame using a known object recognition technology. Specifically, processor 21 detects one or more pixels including worker Pe using a known object recognition technology. Processor 21 specifies a rectangular area Ap including the detected one or more pixels, and determines the center of rectangular area Ap as a position Pp of worker Pe. In the example illustrated in FIG. 6, positions Pp(1) and Pp(2) of workers Pe(1) and Pe(2) are detected.

Processor 21 determines whether or not worker Pe is located in monitoring area Ar set for each process Pr at the imaging time of each frame. Specifically, processor 21 determines that worker Pe is located in monitoring area Ar according to position Pp of worker Pe included in monitoring area Ar. Processor 21 specifies, for each process Pr, a plurality of consecutive frames in which it is determined that worker Pe is located in monitoring area Ar corresponding to process Pr from the moving image. Processor 21 creates a record including process ID for identifying process Pr for the plurality of specified frames. Processor 21 determines the imaging time of the first frame among the plurality of specified frames as the start time of the record, and determines the imaging time of the last frame among the specified frames as the end time of the record. Processor 21 generates second time zone data group 232 including the record created in this way.

<Hardware Configuration Example of Analysis Device>

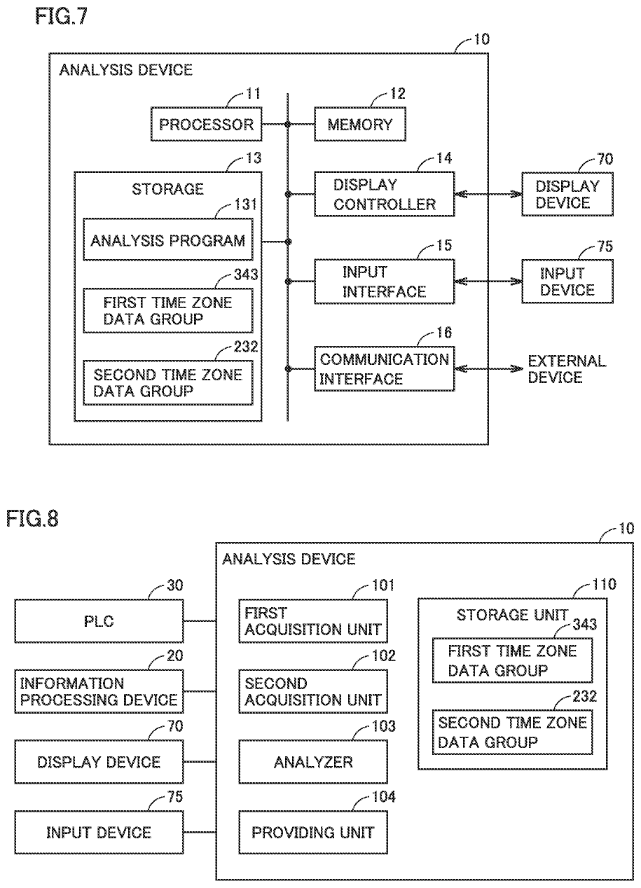

FIG. 7 is a schematic diagram illustrating a hardware configuration example of the analysis device according to the embodiment. Typically, analysis device 10 has a structure according to a general-purpose computer architecture as illustrated in FIG. 7.

Specifically, analysis device 10 includes a processor 11 such as a CPU or an MPU, a memory 12, a storage 13, a display controller 14, an input interface 15, and a communication interface 16. These components are connected to each other via a bus so as to be able to perform data communication.

Processor 11 implements various kinds of processing according to the present embodiment by expanding various programs stored in storage 13 in memory 12 and executing the programs.

Memory 12 is typically a volatile storage device such as a DRAM, and stores a program and the like read from storage 13.

Storage 13 is typically a non-volatile magnetic storage device such as a hard disk drive. Storage 13 stores an analysis program 131 to be executed by processor 11, first time zone data group 343 acquired from PLC 30, and second time zone data group 232 acquired from information processing device 20. Analysis program 131 installed in storage 13 is distributed in a state of being stored in a memory card or the like.

Display controller 14 is connected to display device 70, and outputs a signal for displaying various types of information to display device 70 in accordance with an internal command from processor 11.

Input interface 15 mediates data transmission between processor 11 and an input device 75 such as a keyboard, a mouse, a touch panel, or a dedicated console. That is, input interface 15 receives an operation command given by the user operating input device 75.

Communication interface 16 mediates data transmission between processor 11 and an external device (for example, information processing device 20, PLC 30). Typically, communication interface 16 includes Ethernet (registered trademark), a universal serial bus (USB), and the like. Note that analysis program 131 may be downloaded from a distribution server or the like via communication interface 16.

When a computer having a structure following the general-purpose computer architecture as described above is used, an operating system (OS) for providing basic functions of the computer may be installed in addition to the application for providing the functions according to the present embodiment. In this case, the program according to the present embodiment may execute processing by calling necessary modules in a predetermined order and timing among program modules provided as a part of the OS. That is, the program itself according to the present embodiment does not include the module as described above, and processing may be executed in cooperation with the OS.

Alternatively, a part or all of the functions provided by executing analysis program 131 may be implemented as a dedicated hardware circuit.

<Functional Configuration of Analysis Device>

FIG. 8 is a diagram illustrating a functional configuration example of the analysis device according to the embodiment. As illustrated in FIG. 8, analysis device 10 includes a first acquisition unit 101, a second acquisition unit 102, an analyzer 103, a providing unit 104, and a storage unit 110. First acquisition unit 101 and second acquisition unit 102 are implemented by communication interface 16 and processor 11 that executes analysis program 131. Analyzer 103 is implemented by processor 11 executing analysis program 131. Providing unit 104 is implemented by display controller 14, input interface 15, and processor 11 that executes analysis program 131. Storage unit 110 is implemented by memory 12 and storage 13.

First acquisition unit 101 acquires first time zone data group 343 indicating the first time zone in which a product stays in each of the plurality of processes Pr, and stores the acquired first time zone data group 343 in storage unit 110. First acquisition unit 101 periodically acquires first time zone data group 343 from PLC 30.

Second acquisition unit 102 acquires second time zone data group 232 indicating the second time zone in which a worker stays in each of the plurality of processes Pr, and stores the acquired second time zone data group 232 in storage unit 110. Second acquisition unit 102 periodically acquires second time zone data group 232 from information processing device 20.

Analyzer 103 analyzes the work situation for the product in each of the plurality of processes Pr on the basis of first time zone 60 indicated by first time zone data group 343 and second time zone 62 indicated by second time zone data group 232. In the present embodiment, analyzer 103 determines whether or not a factor of decreasing the work efficiency has occurred on the basis of the relationship between first time zone 60 and second time zone 62.

Providing unit 104 provides an analysis result from analyzer 103. Specifically, providing unit 104 displays a screen indicating the analysis result on display device 70.

<Flow of Analysis Processing>

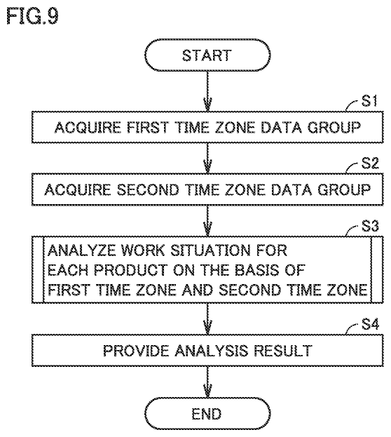

FIG. 9 is a flowchart illustrating a flow of analysis processing by the analysis device according to the embodiment.

Firstly, first acquisition unit 101 of analysis device 10 acquires first time zone data group 343 indicating first time zone 60 in which each product stays in each of the plurality of processes Pr (step S1). Next, second acquisition unit 102 of analysis device 10 acquires second time zone data group 232 indicating second time zone 62 in which a worker stays in each of the plurality of processes Pr (step S2). Note that step S1 may be executed after step S2.

Next, analyzer 103 of analysis device 10 analyzes a work situation for each product in each of the plurality of processes Pr (step S3). Providing unit 104 of analysis device 10 provides an analysis result (step S4). After step S4, the analysis processing ends. Analysis device 10 periodically and repeatedly executes steps S1 to S4.

<Detail of Processing Performed by Analyzer>

Analyzer 103 stores, for each classification of process Pr, information (hereinafter referred to as “association information”) in which a condition for defining the relationship between first time zone 60 and second time zone 62 is associated with a type of a factor that decreases the work efficiency. The classification of process Pr includes “automatic”, “semi-automatic”, and “manual”. The association information for each type of classification is created in advance by a user and registered in analysis device 10.

In process Pr belonging to “automatic” of the classification, processing (machining, attachment of component, inspection, etc.) for the product is automatically executed by one or more devices 40. Therefore, when one or more devices 40 are operating normally, the worker does not enter process Pr belonging to “automatic” of the classification.

In process Pr belonging to “semi-automatic” of the classification, the worker performs preparation work for the processing for the product, and then, the processing (machining, attachment of component, inspection, etc.) for the product is executed by one or more devices 40. For example, as preparation work, the worker inputs a product into device 40 and presses an operation start button of device 40.

In process Pr belonging to “manual” of the classification, one or more devices 40 and a worker execute processing (machining, attachment of component, inspection, etc.) for the product in cooperation.

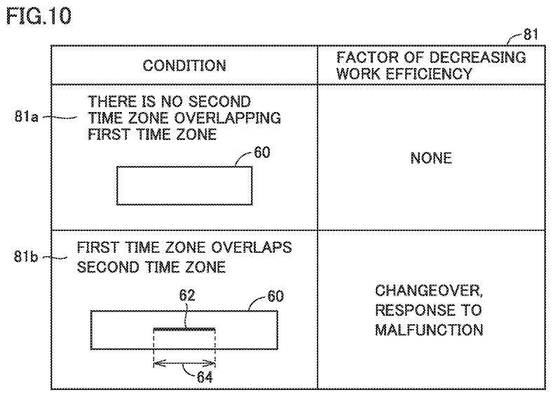

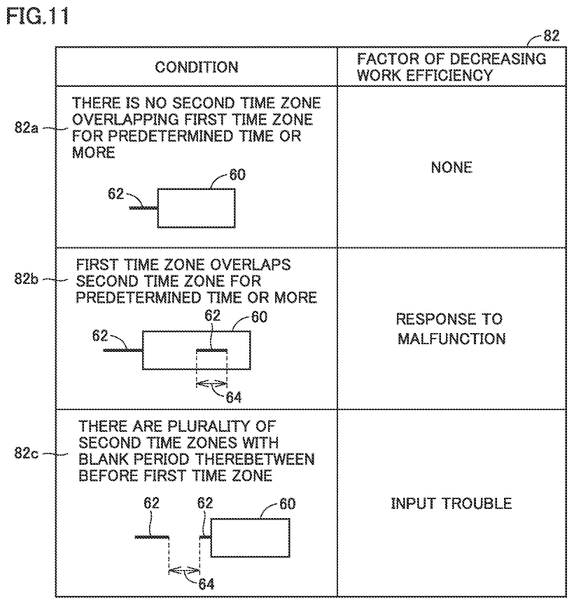

FIG. 10 is a diagram illustrating an example of association information of “automatic” of the classification. As described above, when one or more devices 40 are operating normally, the worker does not enter process Pr belonging to “automatic” of the classification. Therefore, in association information 81, a condition 81a that there is no second time zone 62 overlapping first time zone 60 is associated with “none” as a type of the factor of decreasing work efficiency as illustrated in FIG. 10. Association information 81 associates a condition 81b that first time zone 60 and second time zone 62 overlap each other with “changeover or response to malfunction” as a type of the factor of decreasing work efficiency.

FIG. 11 is a diagram illustrating an example of the association information of “semi-automatic” of the classification. As described above, in process Pr belonging to “semi-automatic” of the classification, the worker performs preparation work for the processing for the product, and then, the processing for the product is executed by one or more devices 40. Therefore, association information 82 associates a condition 82a that there is no second time zone 62 overlapping first time zone 60 for a predetermined time or more with “none” as a type of the factor of decreasing work efficiency as illustrated in FIG. 11. Association information 82 associates a condition 82b that first time zone 60 and second time zone 62 overlap each other for a predetermined time or more with “response to malfunction” as a type of the factor of decreasing work efficiency. Further, association information 82 associates a condition 82c that there is a plurality of second time zones 62 with a blank period therebetween before first time zone 60 with “input trouble” as a type of the factor of decreasing work efficiency.

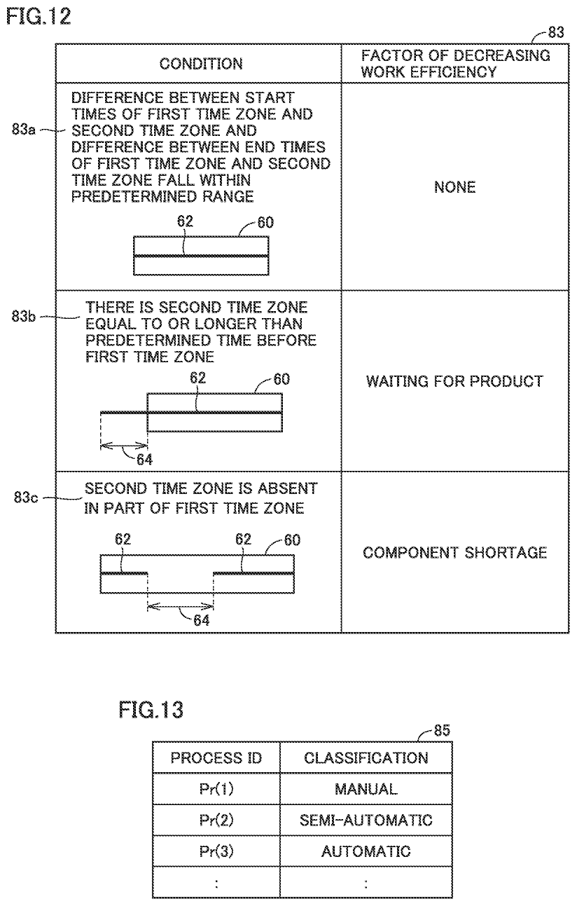

FIG. 12 is a diagram illustrating an example of the association information of “manual” of the classification. As described above, in process Pr belonging to “manual” of the classification, one or more devices 40 and a worker execute processing for the product in cooperation. Therefore, association information 83 associates a condition 83a that a difference between the start time of first time zone 60 and the start time of second time zone 62 and a difference between the end time of first time zone 60 and the end time of second time zone 62 fall within a predetermined range with “none” as a type of the factor of decreasing work efficiency as illustrated in FIG. 12. Association information 83 associates a condition 83b that there is second time zone 62 equal to or longer than a predetermined time before the start time of first time zone 60 with “waiting for product” as a type of the factor of decreasing work efficiency. Further, association information 83 associates a condition 83c that second time zone 62 is absent in a part of first time zone 60 with “component shortage” as a type of the factor of decreasing work efficiency.

FIG. 13 is a diagram illustrating an example of classification information in which process Pr and classification are associated with each other. Analyzer 103 stores classification information 85. Classification information 85 is created in advance by a user and registered in analysis device 10.

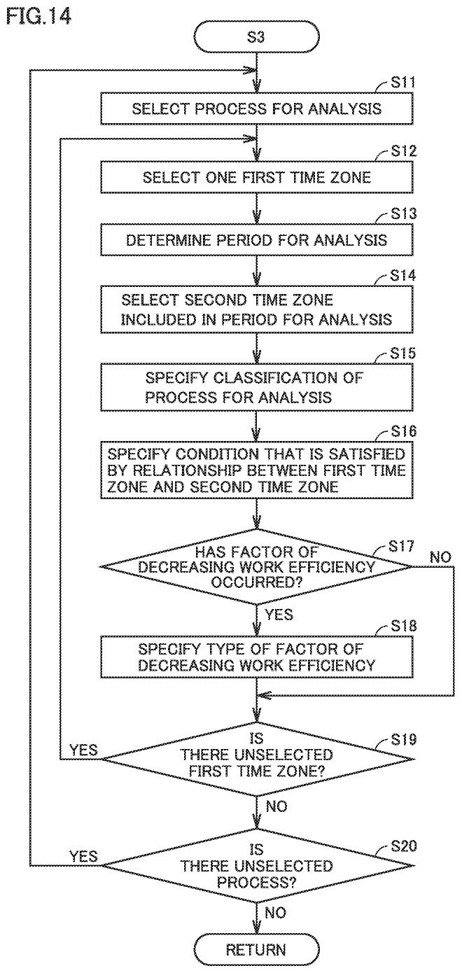

FIG. 14 is a flowchart illustrating a flow of a subroutine of step S3 illustrated in FIG. 9. Steps illustrated in FIG. 14 are executed using the association information illustrated in FIGS. 10 to 12 and the classification information illustrated in FIG. 13.

First, analyzer 103 selects one process Pr from among the plurality of processes Pr as a process for analysis (step S11).

Next, analyzer 103 selects one first time zone 60 of the process for analysis (step S12).

Next, analyzer 103 determines a period for analysis (step S13). Specifically, analyzer 103 determines, as the period for analysis, a period from the end time of first time zone 60 immediately before selected first time zone 60 to the end time of selected first time zone 60 in the process for analysis.

Next, analyzer 103 selects second time zone 62 included in the period for analysis (step S14). When there is no second time zone 62 in the period for analysis, analyzer 103 skips step S14. In a case where there are multiple second time zones 62 in the period for analysis, analyzer 103 selects all of the multiple second time zones 62.

Next, analyzer 103 specifies the classification of the process for analysis using classification information 85 (step S15).

Next, analyzer 103 specifies a condition that is satisfied by the relationship between first time zone 60 and second time zone 62 in the period for analysis of the process for analysis from the association information corresponding to the classification specified in step S15 (step S16).

Next, analyzer 103 determines whether or not a factor that decreases the work efficiency has occurred during the period for analysis of the process for analysis (step S17). Specifically, analyzer 103 determines whether or not the factor corresponding to the condition specified in step S16 is “none”. When the factor is “none”, analyzer 103 determines that no factor of decreasing the work efficiency has occurred.

When the determination in step S17 is YES, analyzer 103 reads the factor corresponding to the condition specified in step S16 from the association information, and specifies the type of the read factor (step S18).

When the determination in step S17 is NO or after step S18, analyzer 103 determines whether or not there is unselected first time zone 60 in the process for analysis (step S19). When the determination in step S19 is YES, the processing returns to step S12.

When the determination in step S19 is NO, analyzer 103 determines whether or not there is unselected process Pr as the process for analysis (step S20). When the determination in step S20 is YES, the processing returns to step S11. When the determination in step S20 is NO, the processing returns to step S4 in FIG. 9.

When determining that the factor of decreasing the work efficiency has occurred (YES in step S17), analyzer 103 may specify a third time zone in which the factor that decreases the work efficiency has occurred in the period for analysis. Analyzer 103 specifies the third time zone according to a condition satisfied by the relationship between first time zone 60 and second time zone 62.

For example, when the relationship between first time zone 60 and second time zone 62 satisfies condition 81b in FIG. 10, analyzer 103 specifies a time zone in which first time zone 60 and second time zone 62 overlap each other for a predetermined time or more as a third time zone 64.

When the relationship between first time zone 60 and second time zone 62 satisfies condition 82b in FIG. 11, analyzer 103 also specifies a time zone in which first time zone 60 and second time zone 62 overlap each other for a predetermined time or more as third time zone 64.

When the relationship between first time zone 60 and second time zone 62 satisfies condition 82c in FIG. 11, analyzer 103 specifies a blank period between a plurality of second time zones 62 before first time zone 60 as third time zone 64.

When the relationship between first time zone 60 and second time zone 62 satisfies condition 83b in FIG. 12, analyzer 103 specifies a period of the second time zone 62 equal to or longer than a predetermined time before first time zone 60 as third time zone 64.

When the relationship between first time zone 60 and second time zone 62 satisfies condition 83c in FIG. 12, analyzer 103 specifies a period having no second time zone 62 in first time zone 60 as third time zone 64.

<Example of Provided Screen>

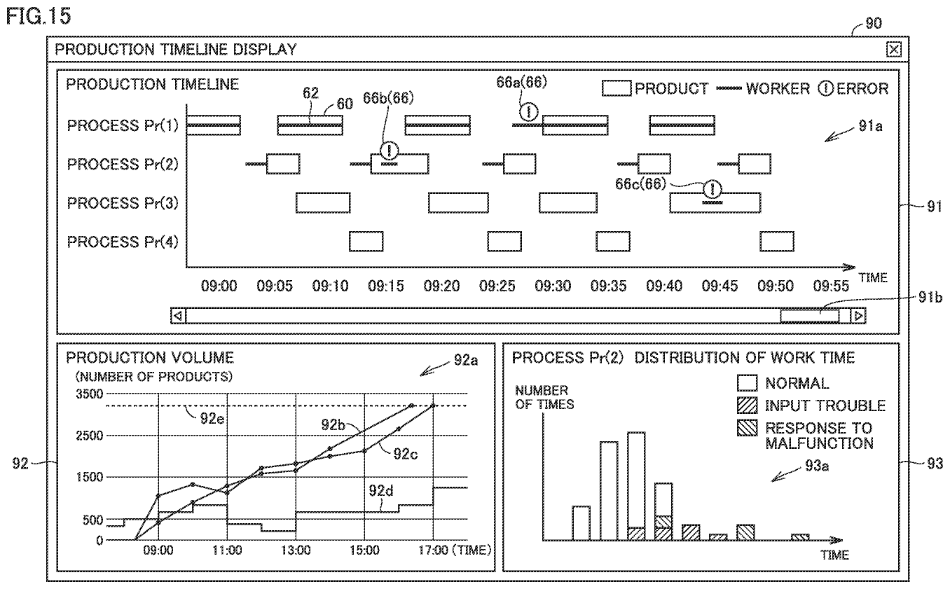

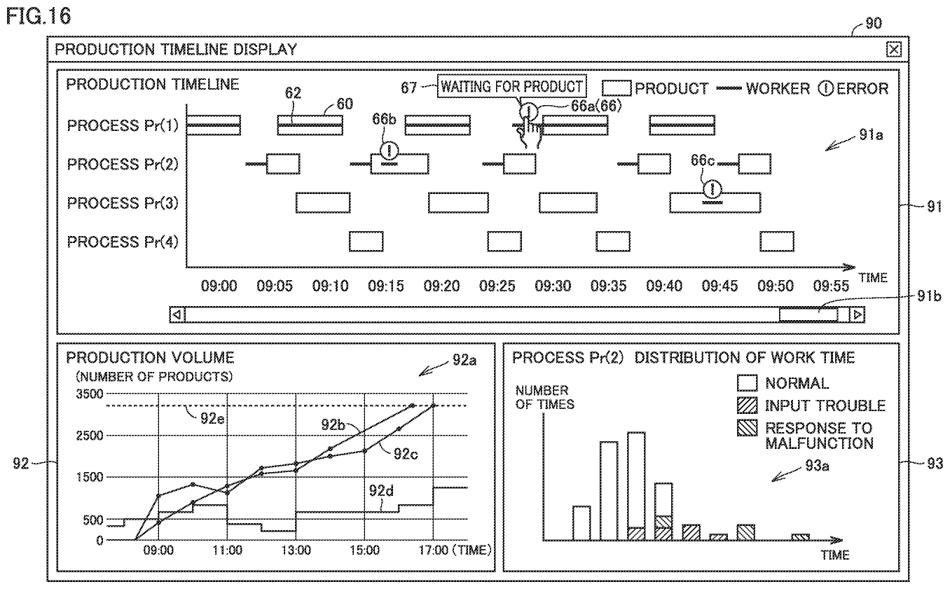

FIG. 15 is a diagram illustrating an example of a screen provided by the analysis device. FIG. 16 is a diagram illustrating another example of the screen provided by the analysis device. A screen 90 illustrated in FIGS. 15 and 16 is provided by providing unit 104 in step S4 of FIG. 9. Screen 90 includes regions 91 to 93.

Providing unit 104 provides a graph 91a that has a vertical axis representing process forward direction and a horizontal axis representing time in region 91. Providing unit 104 displays, in graph 91a, first time zone 60 indicated by first time zone data group 343 and second time zone 62 indicated by second time zone data group 232. In the examples illustrated in FIGS. 15 and 16, first time zone 60 is represented by a box, and second time zone 62 is represented by a solid line. Thus, the user can easily recognize a time zone in which a product stays and a time zone in which a worker stays in each process Pr by viewing graph 91a.

Furthermore, providing unit 104 displays the period for analysis of the process for analysis that has been determined to have a factor of decreasing the work efficiency in a display format different from that of the remaining period in graph 91a. In the examples illustrated in FIGS. 15 and 16, an error mark 66 is displayed to be superimposed on the period for analysis of the process for analysis that has been determined to have a factor of decreasing the work efficiency.

In a case where third time zone 64 (see FIGS. 10 to 12) in which the factor that decreases the work efficiency has occurred is specified, providing unit 104 preferably displays error mark 66 so as to overlap with third time zone 64.

An error mark 66a is displayed to be superimposed on first time zone 60 and second time zone 62 having the relationship satisfying condition 83b illustrated in FIG. 12 in process Pr(1) belonging to “manual” of the classification.

An error mark 66b is displayed to be superimposed on first time zone 60 and second time zone 62 having the relationship satisfying condition 82b illustrated in FIG. 11 in process Pr(2) belonging to “semi-automatic” of the classification.

An error mark 66c is displayed to be superimposed on first time zone 60 and second time zone 62 having the relationship satisfying condition 81b illustrated in FIG. 10 in process Pr(3) belonging to “automatic” of the classification.

The user can easily recognize whether or not a factor of decreasing the work efficiency has occurred by checking error mark 66.

As illustrated in FIG. 16, in response to clicking of one error mark 66, providing unit 104 displays a text 67 indicating the type specified by analyzer 103 for the period for analysis corresponding to error mark 66. As a result, the user can easily recognize the type of the factor of decreasing the work efficiency.

Note that the manner of displaying the period for analysis in the process for analysis that has been determined to have a factor of decreasing the work efficiency in a display format different from that of the remaining period is not limited to displaying error mark 66.

For example, providing unit 104 may display first time zone 60 and second time zone 62 included in the period for analysis of the process for analysis that has been determined to have a factor of decreasing the work efficiency in color different from a color of the remaining time zone. In a case where third time zone 64 in which the factor of decreasing the work efficiency has occurred is specified, providing unit 104 preferably displays third time zone 64 in color different from a color of the remaining time zone.

Alternatively, in a case where third time zone 64 in which the factor of decreasing the work efficiency has occurred is specified, providing unit 104 may change the display format (for example, color) of third time zone 64 depending on the type of the factor specified by analyzer 103. As a result, the user can recognize the type of the factor of decreasing the work efficiency.

Providing unit 104 displays a scroll bar 91b in region 91 and receives an instruction to change the display period of graph 91a. Providing unit 104 changes the display period of graph 91a according to the operation on scroll bar 91b.

Providing unit 104 provides a graph 92a relating to production volume in region 92. Graph 92a is generated based on data acquired from PLC 30 or a production management server (not illustrated). The horizontal axis of graph 92a represents time, and the vertical axis of graph 92a represents the number of products. In graph 92a, a line 92b represents the number of actually manufactured products. A line 92c represents the planned number of products. A line 92d represents the number of products per unit time (per hour in FIGS. 15 and 16). A line 92e represents the target number of products.

The user can select a period of graph 91a displayed in region 91 while viewing graph 92a. For example, the user specifies a period in which the number of products per unit time is low on the basis of graph 92a, and operates scroll bar 91b so that graph 91a of the specified period is displayed in region 91.

Providing unit 104 provides, in region 93, a histogram 93a indicating the distribution of the time required for the work for each product in the process of interest among the plurality of processes Pr. Providing unit 104 receives designation of a process of interest from input device 75, and displays histogram 93a corresponding to the process of interest in region 93 according to the designation. FIGS. 15 and 16 illustrate screen 90 when process Pr(2) is designated as a process of interest.

Providing unit 104 determines, for each product in the process of interest, the time from the earliest clock time to the latest clock time among the clock times included in first time zone 60 and second time zone 62 selected in steps S12 and S14 of FIG. 14 as the time required for the work on the product. Providing unit 104 generates histogram 93a indicating the distribution of time required for work on each product in the process of interest for a predetermined period (for example, past day or past week) or a designated period.

Furthermore, providing unit 104 piles up blocks according to a proportion of the factor for each type in each section of histogram 93a depending on the type of the factor specified on the basis of the relationship between first time zone 60 and second time zone 62 selected in steps S11 and S13. As a result, each section of histogram 93a represents a proportion of the factor specified by analyzer 103 for each type.

The user can easily recognize the factor of an increase in time required for the work by checking histogram 93a of the process of interest.

### First Modification

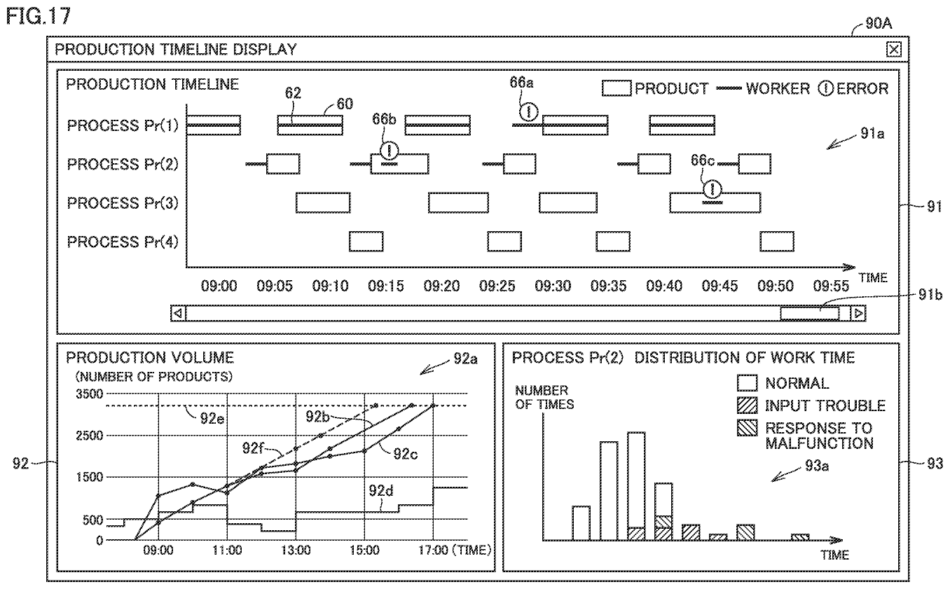

FIG. 17 is a diagram illustrating an example of a screen provided by an analysis device according to a first modification. A screen 90A illustrated in FIG. 17 is different from screen 90 illustrated in FIG. 15 in that a line 92f is added to a graph 92a. Line 92f indicates a transition of the estimated number of products when a factor that decreases the work efficiency is eliminated.

Providing unit 104 executes a simulation of the transition of the number of products in a case of eliminating third time zone 64 having the factor of decreasing the work efficiency, and provides line 92f as a simulation result. Specifically, providing unit 104 simulates the transition of the estimated number of products by eliminating third time zone 64 and shifting first time zone 60 by a period of third time zone 64.

The user can easily recognize how much the production volume increases by eliminating the factor of decreasing the work efficiency by viewing line 92f.

### Second Modification

In the above description, second time zone data group 232 is generated on the basis of the moving image captured by camera 50. However, second time zone data group 232 may be generated using another method.

For example, each worker carries a transmitter that periodically emits a beacon signal. Production site 2 has three or more receivers that receive beacon signals emitted from transmitters. In each cycle, information processing device 20 specifies, on the basis of the strength of the beacon signal received by the three or more receivers, the position of the transmitter that emits the beacon signal and determines in which process the worker is on the basis of the specified position. Information processing device 20 is only required to generate second time zone data group 232 on the basis of the determination result for each cycle.

Alternatively, each worker may carry a card including a radio frequency identifier (RFID) tag and hold the card over a reader installed in each process when entering or exiting the process. Information processing device 20 may generate second time zone data group 232 on the basis of the time at which the reader reads the information of the RFID tag.

### Third Modification

Each record of second time zone data group 232 may include a worker ID for identifying a worker staying in each process Pr.

In a case where second time zone data group 232 is generated on the basis of the operation imaged by camera 50, each worker wears clothing (for example, a cap) on which a uniquely assigned number is printed. In this case, information processing device 20 may specify the worker ID on the basis of the number of the clothing of each worker included in the frame of the moving image, and generate second time zone data group 232 including the worker ID.

Alternatively, when second time zone data group 232 is generated on the basis of a beacon signal from the transmitter, the transmitter emits a beacon signal indicating the worker ID corresponding to the worker carrying the transmitter. In this case, information processing device 20 may generate second time zone data group 232 including the worker ID indicated by the beacon signal.

In a case where second time zone data group 232 is generated using an RFID tag, the RFID tag stores the worker ID corresponding to the worker carrying the RFID tag. The reader installed in each process Pr reads the worker ID from the RFID tag. In this case, information processing device 20 may generate second time zone data group 232 including the worker ID read by the reader.

In a case where the worker ID is included in each record of second time zone data group 232, providing unit 104 may change the display format of second time zone 62 for each worker in graph 91a of screen 90. Thus, the user can easily recognize a flow of each worker between processes Pr by checking graph 91a.

### Fourth Modification

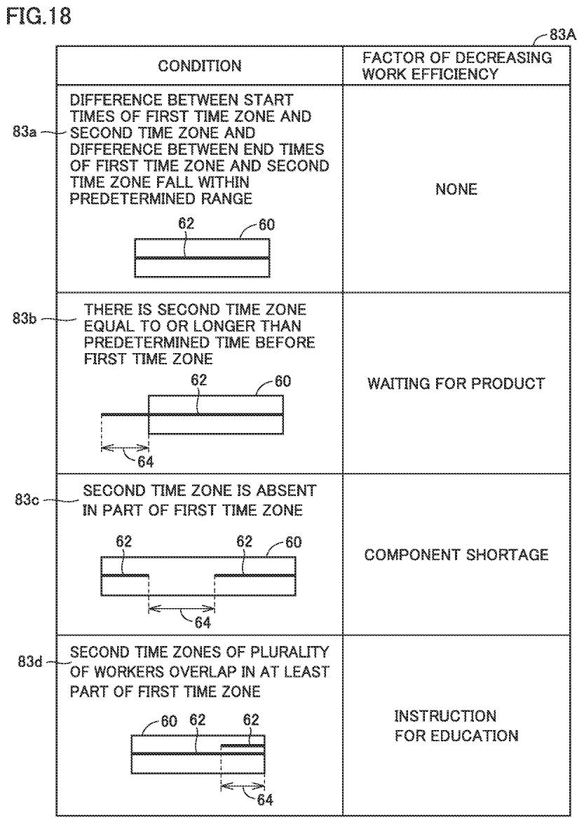

In process Pr classified as “manual”, education can be performed on a new worker by another worker. Such education is one of factors that decrease work efficiency. In view of this, analyzer 103 may store association information 83A illustrated in FIG. 18 in association with “manual” of the classification.

FIG. 18 is a diagram illustrating association information according to a fourth modification. As illustrated in FIG. 18, association information 83A is different from association information 83 illustrated in FIG. 12 in including condition 83d. Condition 83d is a condition that second time zones 62 of a plurality of workers overlap in at least a part of first time zone 60, and is associated with “instruction for education” as a type of the factor of decreasing work efficiency. Analyzer 103 specifies a time zone in which second time zones 62 of the plurality of workers overlap as third time zone 64.

### Fifth Modification

Providing unit 104 according to a fifth modification further has the following functions in addition to the functions of providing unit 104 according to the above-described embodiment.

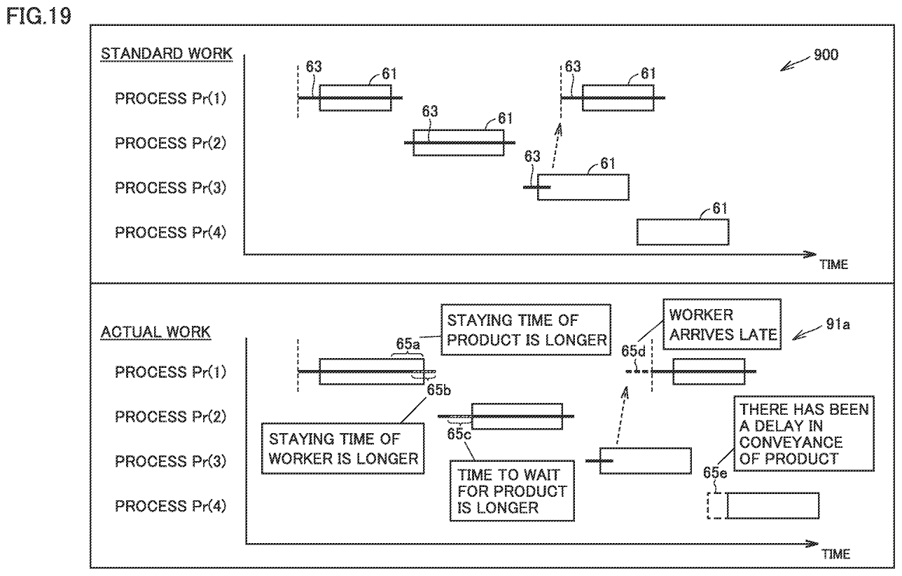

FIG. 19 is a diagram illustrating processing performed by a providing unit of an analysis device according to the fifth modification. Providing unit 104 stores, for each of the plurality of processes Pr, a fourth time zone 61 in which the product stays and a fifth time zone 63 in which the worker stays when standard work is performed. In the upper part of FIG. 19, fourth time zone 61 and fifth time zone 63 are illustrated in a graph 900 that has a vertical axis representing the process forward direction and a horizontal axis representing time.

Providing unit 104 displays a portion different from fourth time zone 61 and fifth time zone 63 in first time zone 60 and second time zone 62 displayed in graph 91a in screen 90 in a display format different from the display format of the remaining portions illustrated in FIGS. 15 and 16. Furthermore, providing unit 104 may display a text indicating the details of difference in graph 91a.

For example, providing unit 104 compares first time zone 60 with fourth time zone 61 for each process Pr, and displays a portion 65a of first time zone 60 longer than fourth time zone 61 by a predetermined time in a display format (for example, color) different from the display format of the remaining portion. Further, providing unit 104 stores in advance a text “staying time of product is longer” in association with a condition “a” that first time zone 60 is longer than fourth time zone 61 by a predetermined time. Providing unit 104 displays the text “staying time of product is longer” associated with condition “a” in the vicinity of portion 65a in response to portion 65a satisfying condition “a”.

Providing unit 104 compares second time zone 62 with fifth time zone 63 for each process Pr, and displays a portion 65b of second time zone 62 longer than fifth time zone 63 by a predetermined time in a display format (for example, color) different from the display format of the remaining portion. Further, providing unit 104 stores in advance a text “staying time of worker is longer” in association with a condition “b” that second time zone 62 is longer than fifth time zone 63 by a predetermined time. Providing unit 104 displays the text “staying time of worker is longer” associated with condition “b” in the vicinity of portion 65b in response to portion 65b satisfying condition “b”.

Providing unit 104 specifies, for each process Pr, a first waiting time zone from the start time of second time zone 62 to the start time of first time zone 60 for first time zone 60 and second time zone 62 which overlap each other. Similarly, providing unit 104 specifies, for each process Pr, a second waiting time zone from the start time of fifth time zone 63 to the start time of fourth time zone 61 for fourth time zone 61 and fifth time zone 63 which overlap each other. Providing unit 104 compares the first waiting time zone and the second waiting time zone, and displays a portion 65c of the first waiting time zone longer than the second waiting time zone by a predetermined time in a display format (for example, color) different from the display format of the remaining portion. Further, providing unit 104 stores in advance a text “time to wait for product is longer” in association with a condition “c” that the first waiting time zone is longer than the second waiting time zone by a predetermined time. Providing unit 104 displays the text “time to wait for product is longer” associated with condition “c” in the vicinity of portion 65c in response to portion 65c satisfying condition “c”.

Providing unit 104 specifies, for a worker moving between a plurality of processes Pr, a first movement time zone from the end time of second time zone 62 of process Pr before the movement to the start time of second time zone 62 of process Pr after the movement. Similarly, providing unit 104 specifies, for a worker moving between a plurality of processes Pr, a second movement time zone from the end time of fifth time zone 63 of process Pr before the movement to the start time of fifth time zone 63 of process Pr after the movement. Providing unit 104 compares the first movement time zone with the second movement time zone, and displays a broken line in a portion 65d of the first movement time zone longer than the second movement time zone by a predetermined time. Further, providing unit 104 stores in advance a text “worker arrives late” in association with a condition “d” that the first movement time zone is longer than the second movement time zone by a predetermined time. Providing unit 104 displays the text “worker arrives late” associated with condition “d” in the vicinity of portion 65d in response to portion 65d satisfying condition “d”.

Providing unit 104 specifies, for a product conveyed between a plurality of processes Pr, a first conveyance time zone from the end time of first time zone 60 of process Pr before the conveyance to the start time of first time zone 60 of process Pr after the conveyance. Similarly, providing unit 104 specifies, for a product conveyed between a plurality of processes Pr, a second conveyance time zone from the end time of fourth time zone 61 of process Pr before the conveyance to the start time of fourth time zone 61 of process Pr after the conveyance. Providing unit 104 compares the first conveyance time zone with the second conveyance time zone, and displays a block in broken line in a portion 65e of the first conveyance time zone longer than the second conveyance time zone by a predetermined time. Further, providing unit 104 stores in advance a text “there has been a delay in conveyance of product” in association with a condition “e” that the first conveyance time zone is longer than the second conveyance time zone by a predetermined time. Providing unit 104 displays the text “there has been a delay in conveyance of product” associated with condition “e” in the vicinity of portion 65e in response to portion 65e satisfying condition “e”.

According to the fifth modification, the user can easily recognize a portion different from the standard work by checking graph 91a in screen 90.

### § 3 SUPPLEMENTARY MATTER

As described above, the present embodiment includes the following disclosures.

(Configuration 1)

An analysis device (10) in a manufacturing system (1) including a plurality of processes (Pr), the analysis device (10) comprising:

a first acquisition unit (101, 11) configured to acquire data (343) indicating a first time zone (60) in which each product stays in each of the plurality of processes (Pr);

a second acquisition unit (102, 11) configured to acquire data (232) indicating a second time zone (62) in which a worker stays in each of the plurality of processes (Pr);

an analyzer (103, 11) configured to analyze a work situation for each product in each of the plurality of processes (Pr); and

a providing unit (104, 11) configured to provide an analysis result from the analyzer (103, 11), wherein

the analyzer (103, 11) determines, on the basis of a first relationship between the first time zone (60) and the second time zone (62) in a period for analysis of a process for analysis, whether or not a factor that decreases work efficiency has occurred in the period for analysis of the process for analysis.

(Configuration 2)

The analysis device (10) according to Configuration 1, wherein

the analyzer (103, 11) is further configured to

store, for each classification of processes, information (81 to 83) in which a condition for defining a relationship between the first time zone (60) and the second time zone (62) and a type of the factor that decreases work efficiency are associated with each other, and

specify, for each of the plurality of processes (Pr), the type of the factor associated with the condition satisfied by the first relationship from the information (81 to 83) corresponding to the classification to which the process belongs.

(Configuration 3)

The analysis device (10) according to Configuration 1 or 2, wherein

the providing unit (104, 11)

provides a graph (91a) with a first axis representing a process forward direction and a second axis representing time,

displays the first time zone (60) and the second time zone (62) on the graph (91a), and

displays the time zone that has been determined to have the factor in a display format different from a display formant of a remaining time zone.

(Configuration 4)

The analysis device (10) according to Configuration 2, wherein

the analyzer (103, 11) specifies a third time zone (64) in which the factor occurs in the first time zone and the second time zone that have been determined to have the factor, and

the providing unit (104, 11)

provides a graph (91a) with a first axis representing a process forward direction and a second axis representing time,

displays the first time zone (60) and the second time zone (62) on the graph (91a), and

displays the third time zone (64) in a different display format depending on the type of the factor specified by the analyzer (103, 11).

(Configuration 5)

The analysis device (10) according to Configuration 2, wherein

the providing unit (104, 11)

provides a graph (91a) with a first axis representing a process forward direction and a second axis representing time,

displays the first time zone (60) and the second time zone (62) on the graph (91a), and

displays, in the graph (91a), a text indicating the type of the factor specified by the analyzer (103, 11) in the period for analysis that has been determined to have the factor.

(Configuration 6)

The analysis device (10) according to any one of Configuration 3 to Configuration 5, wherein

the providing unit (104, 11)

stores, for each of the plurality of processes (Pr), a fourth time zone (61) in which the product stays and a fifth time zone (63) in which the worker stays when standard work is performed, and

displays a portion, in the first time zone (60) and the second time zone (62) displayed in the graph (91a), different from the fourth time zone (61) and the fifth time zone (63) in a display format different from a display format of a remaining portion.

(Configuration 7)

The analysis device (10) according to Configuration 2, wherein

the providing unit (104, 11) provides a histogram (93a) indicating a distribution of time required for work on each product in a process of interest among the plurality of processes (Pr), and

each section of the histogram (93a) represents a proportion of the factor identified by the analyzer (103, 11) for each type.

(Configuration 8)

The analysis device (10) according to any one of Configuration 1 to Configuration 3, wherein

the analyzer (103, 11) specifies a third time zone (64) in which the factor occurs in the first time zone and the second time zone that have been determined to have the factor, and

the providing unit (104, 11) further provides a simulation result of transition of a production volume of the product in a case of eliminating the third time zone (64).

(Configuration 9)

An analysis method for a manufacturing system (1) including a plurality of processes (Pr), the analysis method comprising:

acquiring (S1) data (343) indicating a first time zone (60) in which each product stays in each of the plurality of processes (Pr);

acquiring (S2) data (232) indicating a second time zone (62) in which a worker stays in each of the plurality of processes (Pr);

analyzing (S3) a work situation for each product in each of the plurality of processes (Pr); and

providing (S4) an analysis result, wherein

the analyzing (S3) includes determining (S17), on the basis of a relationship between the first time zone (60) and the second time zone (62) in a period for analysis of a process for analysis, whether or not a factor that decreases work efficiency has occurred in the period for analysis of the process for analysis.

(Configuration 10)

A program (131) for causing a computer (101) to execute an analysis method for a manufacturing system (1) including a plurality of processes (Pr), the analysis method comprising:

acquiring (S1) data (343) indicating a first time zone (60) in which each product stays in each of the plurality of processes (Pr);

acquiring (S2) data (232) indicating a second time zone (62) in which a worker stays in each of the plurality of processes (Pr);

analyzing (S3) a work situation for each product in each of the plurality of processes (Pr); and

providing (S4) an analysis result, wherein

the analyzing (S3) includes determining (S17), on the basis of a relationship between the first time zone (60) and the second time zone (62) in a period for analysis of a process for analysis, whether or not a factor that decreases work efficiency has occurred in the period for analysis of the process for analysis.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An analysis device in a manufacturing system including a plurality of processes, the analysis device comprising:
a first acquisition unit configured to acquire data indicating a first time zone in which each product stays in each of the plurality of processes;
a second acquisition unit configured to acquire data indicating a second time zone in which a worker stays in each of the plurality of processes;
an analyzer configured to analyze a work situation for each product in each of the plurality of processes; and
a providing unit configured to provide an analysis result from the analyzer, wherein
the analyzer determines, on the basis of a first relationship between the first time zone and the second time zone in a period for analysis of a process for analysis, whether or not a factor that decreases work efficiency has occurred in the period for analysis of the process for analysis.

2. The analysis device according to claim 1, wherein
the analyzer is further configured to:
store, for each classification of processes, information in which a condition for defining a relationship between the first time zone and the second time zone and a type of the factor that decreases work efficiency are associated with each other; and
specify, for each of the plurality of processes, the type of the factor associated with the condition satisfied by the first relationship from the information corresponding to the classification to which the process belongs.

3. The analysis device according to claim 1, wherein
the providing unit:
provides a graph with a first axis representing a process forward direction and a second axis representing time;
displays the first time zone and the second time zone on the graph; and
displays the period for analysis that has been determined to have the factor in a display format different from a display formant of a remaining period.

4. The analysis device according to claim 2, wherein
the analyzer specifies a third time zone in which the factor occurs in the period for analysis that has been determined to have the factor, and
the providing unit:
provides a graph with a first axis representing a process forward direction and a second axis representing time;
displays the first time zone and the second time zone on the graph; and
displays the third time zone in a different display format depending on the type of the factor specified by the analyzer.

5. The analysis device according to claim 2, wherein
the providing unit:
provides a graph with a first axis representing a process forward direction and a second axis representing time;
displays the first time zone and the second time zone on the graph; and
displays, in the graph, a text indicating the type of the factor specified by the analyzer in the period for analysis that has been determined to have the factor.

6. The analysis device according to claim 3, wherein
the providing unit:
stores, for each of the plurality of processes, a fourth time zone in which the product stays and a fifth time zone in which the worker stays when standard work is performed; and
displays a portion, in the first time zone and the second time zone displayed in the graph, different from the fourth time zone and the fifth time zone in a display format different from a display format of a remaining portion.

7. The analysis device according to claim 4, wherein
the providing unit:
stores, for each of the plurality of processes, a fourth time zone in which the product stays and a fifth time zone in which the worker stays when standard work is performed; and
displays a portion, in the first time zone and the second time zone displayed in the graph, different from the fourth time zone and the fifth time zone in a display format different from a display format of a remaining portion.

8. The analysis device according to claim 5, wherein
the providing unit:
stores, for each of the plurality of processes, a fourth time zone in which the product stays and a fifth time zone in which the worker stays when standard work is performed; and
displays a portion, in the first time zone and the second time zone displayed in the graph, different from the fourth time zone and the fifth time zone in a display format different from a display format of a remaining portion.

9. The analysis device according to claim 2, wherein
the providing unit provides a histogram indicating a distribution of time required for work on each product in a process of interest among the plurality of processes, and
each section of the histogram represents a proportion of the factor identified by the analyzer for each type.

10. The analysis device according to claim 1, wherein
the analyzer specifies a third time zone in which the factor occurs in the period for analysis that has been determined to have the factor, and
the providing unit further provides a simulation result of transition of a production volume of the product in a case of eliminating the third time zone.

11. An analysis method for a manufacturing system including a plurality of processes, the analysis method comprising:
acquiring data indicating a first time zone in which each product stays in each of the plurality of processes;
acquiring data indicating a second time zone in which a worker stays in each of the plurality of processes;
analyzing a work situation for each product in each of the plurality of processes; and
providing an analysis result, wherein
the analyzing includes determining, on the basis of a relationship between the first time zone and the second time zone in a period for analysis of a process for analysis, whether or not a factor that decreases work efficiency has occurred in the period for analysis of the process for analysis.

12. A non-transitory computer-readable storage medium that stores a program for causing a computer to execute an analysis method for a manufacturing system including a plurality of processes, the analysis method comprising:
acquiring data indicating a first time zone in which each product stays in each of the plurality of processes;
acquiring data indicating a second time zone in which a worker stays in each of the plurality of processes;
analyzing a work situation for each product in each of the plurality of processes; and
providing an analysis result, wherein
the analyzing includes determining, on the basis of a relationship between the first time zone and the second time zone in a period for analysis of a process for analysis, whether or not a factor that decreases work efficiency has occurred in the period for analysis of the process for analysis.
